(19) United States
(12) Patent Application Publication
(10) Pub. No.: US 2025/0269747 A1
(43) Pub. Date: Aug. 28, 2025

(54) CHARGING CONTROL SYSTEM AND METHOD

(71) Applicants: Hyundai Motor Company, Seoul (KR); Kia Corporation, Seoul (KR)

(72) Inventors: Sung-Hun Kim, Hwaseong-si (KR); Jin-Su Jang, Hwaseong-si (KR); Jong-Yoon Chae, Hwaseong-si (KR)

(21) Appl. No.: 18/944,832

(22) Filed: Nov. 12, 2024

(30) Foreign Application Priority Data
Feb. 22, 2024 (KR) 10-2024-0025696

(51) Int. Cl. B60L 53/22; B60L 53/10

(52) U.S. Cl. CPC B60L 53/22; B60L 53/10; B60L 2210/10; B60L 2210/30

(57) ABSTRACT

A system capable of charging connection to both a conventional charging port and an automatic connection device (ACD) can include a vehicle having an on-board charger connected to a plurality of charging ports, and an external charger electrically, communicatively connected to the vehicle and providing at least one of first charging power converted by transmitting supply power from a distribution board to the on-board charger and second charging power converted through a built-in power converter so that single charging or combined charging can be performed by changing a plurality of charging lines.

### CROSS-REFERENCE TO RELATED APPLICATIONS

This application claims the benefit of Korean Patent Application No. 10-2024-0025696, filed on Feb. 22, 2024, which application is hereby incorporated herein by reference.

### TECHNICAL FIELD

The present disclosure relates to a charging control technology.

### BACKGROUND

A home charging device is a device for receiving a single-phase or three-phase alternating current (AC), undergoing two-stage power conversion, and supplying a charging current based on a direct current (DC) voltage of an electric vehicle to a vehicle battery.

Conventional home charging devices connect charging based on a combined charging system (CCS), such as CCS1 and CCS2 type charging ports (i.e., inlets), and DC charging communication is implemented based on power line communication (PLC). In addition, an automatic connection device (ACD) may be used for charging connection.

The ACD is a device for automatically connecting a charging port to a charger without human connection by coupling a conventional charging port (i.e., an inlet) to a robot. Conductive charging is performed in the same manner as the conventional charging port, but charging connection is possible through the automated robot instead of a human.

That is, the ACD functions to replace a connection operation of the charging port while electrical charging performance is the same as that of the conventional charging port.

Among current ACD devices, electric vehicles with an automatic connection device-underbody (ACD-U) devices require two types of charging ports to use both charging port-centered charging infrastructure and ACD-U for compatibility with the conventional infrastructure.

Even when electric vehicles have the two types of charging ports, the charging infrastructure has a structure capable of charging using only one of the conventional charging port or the ACD. In addition, there is a problem that the charging capacity is also limited to the maximum capacity of a DC charger.

That is, electric vehicles with an ACD-U system have two charging ports for the conventional charging port and the ACD-U, but have an inefficiency problem of charging through only one charging port.

In addition, there is a problem that because the conventional charging port cannot be used in the case of using a charger connected only to the ACD-U, charging may not be made when the ACD-U device fails.

### SUMMARY

The present disclosure relates to a charging control technology, and more specifically, to a system and method for controlling maximum charging using a home charging device.

An embodiment of the present disclosure can solve the problems note above by providing a system and method capable of charging connection to both a conventional charging port and an automatic connection device (ADC).

In addition, an embodiment of the present disclosure can provide a system and method, which may increase a charging capacity and/or speed through simultaneous charging control of an in-vehicle charging device and a home charging device using two charging ports at the same time.

An embodiment of the present disclosure can provide a system capable of charging connection to both a conventional charging port and an ADC.

In embodiment of the present disclosure, a system can include a vehicle having an on-board charger connected to a plurality of charging ports, and an external charger electrically, communicatively connected to the vehicle and providing at least one of first charging power converted by transmitting supply power from a distribution board to the on-board charger and second charging power converted through a built-in power converter so that single charging, or combined charging can be performed by changing a plurality of charging lines.

The plurality of charging lines may include an AC charging line through which AC power is supplied to the on-board charger and a DC charging line through which DC power is directly supplied to the vehicle using the external charger without passing through the on-board charger.

The AC charging line may be connected between an output terminal of the distribution board and an input terminal of the power converter and disconnected in the external charger.

The plurality of charging ports may be combo-type charging ports connected to both the AC charging line and the DC charging line.

The DC charging line may be connected to an output terminal of a DC-DC converter configured in the power converter.

The single charging may be performed when a charging connector installed on the external charger is connected to a first charging port among the plurality of charging ports, or an automatic connection unit installed on the external charger is automatically connected to a second charging port among the plurality of charging ports configured in a combo charging port unit installed in the vehicle.

The combined charging may be performed when a charging connector installed on the external charger is connected to a first charging port among the plurality of charging ports, and at the same time, an automatic connection unit installed on the external charger is automatically connected to a second charging port among the plurality of charging ports configured in a combo charging port unit installed in the vehicle.

The automatic connection unit and the combo charging port unit may be connected by using any one of a wireless charging method, an automatic connection device-underbody (ACD-U), or an automatic connection device-sidebody (ACD-S).

The combined charging may be a capacity of the sum of the first charging power generated by the on-board charger and the second charging power generated by the power converter by controlling the on-board charger and the power converter through a parallel operation.

The external charger may include a bypass circuit having a plurality of switching elements connected in parallel so that the plurality of charging lines can be changed.

The plurality of charging ports may be disposed at different locations of the vehicle.

The system may include a first sensor disposed at an output terminal of the power converter to sense a first output current to apply a control signal to the power converter, and a second sensor disposed at an output terminal of the on-board charger to sense a second output current to apply a control signal to the on-board charger.

The on-board charger and the power converter may be converters with an insulated structure in which an input circuit network and an output circuit network are insulated electrically by a transformer.

According to an embodiment of the present disclosure, a charging control method can include electrically, communicatively connecting a vehicle having an on-board charger connected to a plurality of charging ports to an external charger having a built-in power converter, and performing, by an external charger, single charging or combined charging that provides first charging power converted by transmitting supply power from a distribution board to the on-board charger and/or second charging power converted through the power converter.

According to an embodiment of the present disclosure, by increasing charging power using only one charging port and constituting the AC bypass circuit to efficiently use two charging ports, charging connection to both the conventional charging port and the ADC can be possible.

According to an embodiment of the present disclosure, it can be possible to increase the charging capacity and/or speed through simultaneous charging control of the in-vehicle charging device and the home charging device using two charging ports at the same time.

According to an embodiment of the present disclosure, by using one of the two charging ports for AC charging and the other for DC charging, the power conversion module of each of the on-board charger (OBD) and the external charger can be used. Therefore, charging to the charging capacity higher than the capacity of the same charger can be possible without increasing the additional charging power conversion module.

According to an embodiment of the present disclosure, because the additional charging power conversion module is not necessarily required, there can be an advantage of no additional fee.

A system and method according to embodiments of the present disclosure can be applicable to vehicles with both the ACD-U and the conventional charging port by defining the international standard-based communication method.

### BRIEF DESCRIPTION OF THE DRAWINGS

FIG. 1 is a block diagram of a configuration of a charging control system according to an embodiment of the present disclosure.

FIG. 2 is a diagram showing a concept of charging between an external charger and a vehicle in the charging control system shown in FIG. 1, according to an embodiment of the present disclosure.

FIG. 3 is a conceptual diagram showing that simultaneous charging is possible using an on-board charger and an external charger by adding a bypass circuit using a combo-type charging port according to the concept of charging shown in FIG. 2, using an embodiment of the present disclosure.

FIG. 4 is a conceptual diagram showing that charging control is possible at maximum power regardless of which of two types of charging ports are used according to the concept of charging shown in FIG. 2, using an embodiment of the present disclosure.

FIG. 5 is a block diagram of a configuration of the external charger shown in FIG. 1, according to an embodiment of the present disclosure.

FIG. 6 is a block diagram of a configuration of a vehicle shown in FIG. 2, according to an embodiment of the present disclosure.

FIG. 7 is a flowchart showing a combined charging or single charging process according to an embodiment of the present disclosure.

FIG. 8 is a conceptual diagram showing the execution of maximum charging through the combined charging according to an embodiment of the present disclosure.

FIG. 9 is a conceptual diagram of single charging using only the conventional charging port according to an embodiment of the present disclosure.

FIG. 10 is a conceptual diagram of single charging using only an automatic connection device (ADC) according to an embodiment of the present disclosure.

### DETAILED DESCRIPTION OF ILLUSTRATIVE EMBODIMENTS

The above-described features and advantages will be described below in detail regarding example embodiments and with reference to the accompanying drawings, and thus those skilled in the art to which the present disclosure pertains can carry out the technical spirit of the present disclosure. In describing the present disclosure, when it is determined that a detailed description of known technology related to the present disclosure may unnecessarily obscure the gist of the present disclosure, a detailed description thereof can be omitted.

Hereinafter, example embodiments of the present disclosure will be described in detail with reference to the accompanying drawings. In the drawings, same reference numerals can be used to denote same or similar components.

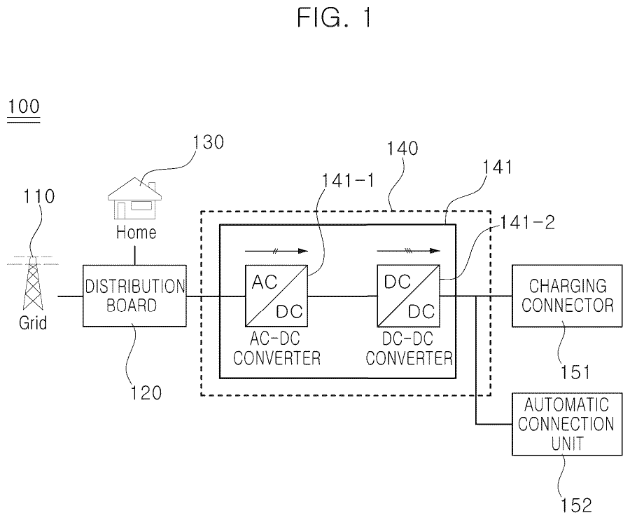

FIG. 1 is a block diagram of a configuration of a charging control system 100 according to an embodiment of the present disclosure. Referring to FIG. 1, the charging control system 100 may include a grid 110, a distribution board 120, an external charger 140, a charging connector 151, an automatic connection unit 152, etc, any combination of or all of which may be in plural or may include plural components thereof.

The grid 110 can be a network interconnected to supply power from power producers to power consumers.

The distribution board 120 can perform a function of branching power supplied from the grid 110 to electric devices of a customer 130 and the external charger 140 according to applications and system. The distribution board 120 can be composed of a branch circuit, a circuit breaker, an earth leakage breaker, etc.

The external charger 140 may include a power converter 141 for converting AC power into DC power or increasing or decreasing DC power into another DC power. The power converter 141 can be composed of an AC-DC converter 141-1 for converting AC power into DC power, and a DC-DC converter 141-2 for increasing and decreasing one DC power into another DC power.

The AC-DC converter 141-1 and the DC-DC converter 141-2 can be each composed of a plurality of switching elements, transformers, capacitors, inductors, etc. that constitute a bridge circuit. Examples of the plurality of switching elements may include semiconductor switching elements such as field effect transistors (FETs), metal oxide semiconductor FETs (MOSFETs), insulated gate bipolar mode transistors (IGBTs), and power rectifier diodes, thyristors, gate turn-off (GTO) thyristors, and triodes for alternating current (TRIACs), silicon controlled rectifiers (SCRs), IC circuits, etc.

In particular, as the semiconductor switching element, bipolar or power MOSFET elements, etc. may be used. The power MOSFET elements can operate at high voltage and high current and unlike general MOSFETs, can have a double-diffused metal oxide semiconductor (DMOS) structure.

The charging connector 151 can be connected to the power converter 141 and connected by being inserted into a charging port (not shown) installed in a vehicle. Therefore, the charging connector 151 can perform a function of electrically connecting the external charger 140 to the vehicle. The charging connector 151 can perform a function of communicatively connecting the external charger 140 to the vehicle.

The automatic connection unit 152 can perform a function of automatically connecting the external charger 140 to the vehicle 20 using an automatic connection device (ACD) technology. The ACD technology can be implemented through a communication-based control technology such as an electric vehicle, a charging connector, a charging pad, or a robot gun, for example.

In particular, the automatic connection unit 152 can be an automatic connection device-underbody (ACD-U) and perform a function of automatically connecting the charging port to the external charger 140 without human connection by coupling a charging port (i.e., an inlet) installed at the bottom of the vehicle to a robot. The automatic connection unit 152 may include a charging connector, a charging pad, a robot gun, a microcomputer, a microprocessor, an electronic circuit, a gripper, etc., for example.

A wireless charging method and an automatic connection device-sidebody (ACD-S) can be also possible. In the case of a wireless charging method, a wireless power transmission pad can be installed on the floor where the external charger 140 is installed, and a wireless power reception pad can be also installed at the bottom of the vehicle. In other words, the wireless power transmission pad can be composed of a primary coil, the wireless power reception pad can be composed of a secondary coil, and charging can be performed through magnetic induction between the primary coil and the secondary coil.

In the case of ACD-S, a charging port can be installed on a side surface of the vehicle, and the charging port and the external charger 140 can be connected through a robot arm.

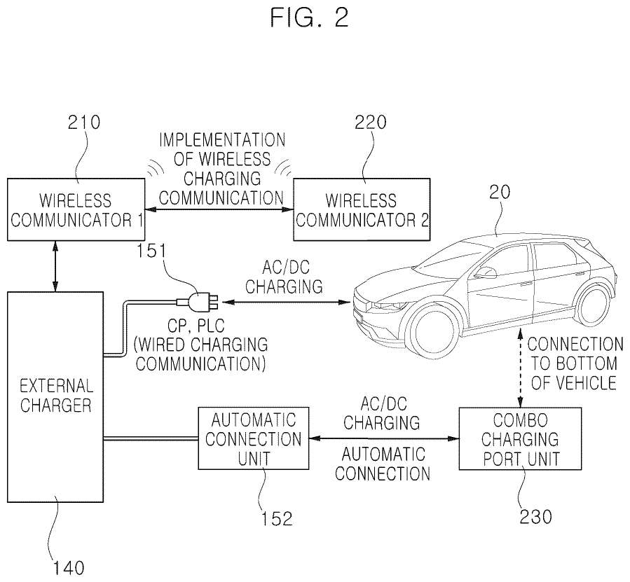

FIG. 2 is a view showing a concept of charging between the external charger 140 and a vehicle 20 in the charging control system 100 shown in FIG. 1. Referring to FIG. 2, first, the charging connector 151 can be connected to a general charging port (not shown) of the vehicle 20, and in addition, the automatic connection unit 152 can be automatically connected to a combo charging port unit 230 installed at the bottom of the vehicle 20. FIG. 2 shows that the combo charging port unit 230 can be disposed at the bottom of the vehicle 20, but the combo charging port unit 230 may be disposed on a side surface or upper end surface of the vehicle 20.

Through connection between the charging connector 151 and the general charging port (not shown) of the vehicle 20, the external charger 140 and the vehicle 20 can be connected in a wired charging communication manner. That is, the external charger 140 and the vehicle 20 can exchange data about charging by loading a control pilot (CP) signal with power line communication (PLC). Typically, the CP signal can be about 1 kHz pulse width modulation (PWM) waveform at about ±12 V, for example.

The combo charging port unit 230 may include a combo charging port (not shown), and a sensor for recognizing a location and/or approach of the automatic connection unit 152, etc. The combo charging port (not shown) can be a charging port in which pins are arranged to selectively perform slow charging or fast charging. Therefore, slow charging or fast charging can be possible using one charging port.

The general charging port can be also a combo type charging port. Therefore, AC charging or DC charging may be performed through the charging connector 151.

Using the combo type of two charging ports to implement simultaneous charging, AC charging may be performed through the charging connector and the on-board charger, and DC charging may increase a charging capacity without an additional power conversion module through the automatic connection unit 152 and the combo charging port unit 230.

Referring to FIG. 2, wireless communication for charging control using the automatic connection unit 152 can be performed between a first wireless communicator 210 configured in the external charger 140 and a second wireless communicator 220 configured in the vehicle 20. In this case, the wireless communication may be infrared data (IrDA) communication, wireless local area network (LAN), ZigBee, Bluetooth, light fidelity (LiFi), wireless fidelity (WiFi), near field control (NFC), etc., for example.

Therefore, the maximum charging may be implemented by using wired charging communication through the charging connector 151 and the general charging port (not shown) and using wireless charging communication through the automatic connection unit 152 and the combo charging port unit 230.

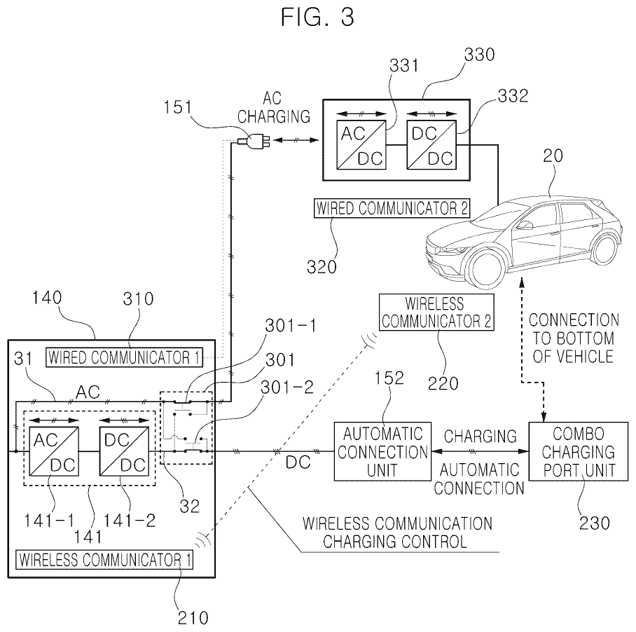

FIG. 3 is a conceptual diagram showing that simultaneous charging can be possible using an on-board charger 330 and the external charger 140 by adding a bypass circuit 301 using a combo-type charging port according to the concept of charging shown in FIG. 2, in an embodiment of the present disclosure. Referring to FIG. 3, the external charger 140 may include the power converter 141, a first wired communicator 310, the bypass circuit 301, the first wireless communicator 210, etc.

The vehicle side may also include a second wired communicator 320, the on-board charger 330, the second wireless communicator 220, etc. to be connected to components of the external charger 140.

The bypass circuit 301 can include a first switching element 301-1 and a second switching element 301-2 in parallel. A 1-1 charging line 31 connecting an output terminal of the distribution board 120, an input terminal of the AC-DC converter 141-1, the first switching element 301-1, and the charging connector 151 by an operation of the bypass circuit 301 can be formed. The 1-1 charging line 31 may be disconnected in the external charger 140.

In addition, a 1-2 charging line 32 connecting an output terminal of the DC-DC converter 141-2, the second switching element 301-2, and the automatic connection unit 152 can be formed.

The other ends of the first switching element 301-1 and the second switching element 301-2 can be connected to the charging connector 151 and the automatic connection unit 152, respectively. That is, the other end of the first switching element 301-1 can be connected to the charging connector 151, and the other end of the second switching element 301-2 can be connected to the automatic connection unit 152.

The first switching element 301-1 and the second switching element 301-2 may be electromagnetic relays, semiconductor relays, etc. Therefore, the 1-1 charging line 31 connecting the output terminal of the distribution board 120, the input terminal of the AC-DC converter 141-1, and the charging connector 151 according to the operation of the first switching element 301-1 may be formed.

In addition, the 1-2 charging line 32 connecting an output terminal of the power converter 141 to the automatic connection unit 152 according to the operation of the second switching element 301-2 may be formed. That is, the charging line may be changed through the first switching element 301-1 and the second switching element 301-2.

The wired communicators 310 and 320 and the wireless communicators 210 and 220 may include a communication circuit, a microprocessor, etc.

In FIG. 3, the first line 31 is shown in a state of being connected to the charging connector 151, and the second line 32 is shown in a state of being connected to the automatic connection unit 152. Therefore, the AC charging can be performed through the charging connector 151 and the on-board charger 330, and the DC charging can be performed through the automatic connection unit 152 and the on-board charger 330. And therefore, a total of combined charging of about 44 kW can be possible, for example.

The on-board charger 330 can be composed of an AC-DC converter 331 and a DC-DC converter 332. The AC-DC converter 331 can convert AC power into DC power and supply DC charging power to a battery (not shown) installed inside the vehicle 20. Meanwhile, the external charger 140 can be a DC charger for supplying DC charging power to the vehicle 20 and supply the DC charging power directly to a battery (not shown) installed inside the vehicle 20 without the on-board charger 330.

That is, the AC-DC converters 141-1 and 331 and the DC-DC converters 141-2 and 332 that are configured in the on-board charger 330 and the external charger 140 can be operated in parallel, making it possible to maximally control the charging capacity. That is, the AC charging line 31 can supply AC power to the on-board charger 330 so that the AC power is converted into DC charging power in the on-board charger 330.

In addition, in the case of the DC charging line 32, DC charging power can be output through the power converter 141 configured in the external charger 140. That is, the AC power supplied from the distribution board 120 can be output by being converted into DC charging power through the AC-DC converter 141-1 and the DC-DC converter 141-2 configured in the power converter 141.

Therefore, combined charging can be possible, and the combined charging may result in a charging capacity of about 44 kW, for example, which is the sum of about 22 kW supplied through the AC charging line 31 and about 22 kW supplied through the DC charging line 32.

Similar to the external charger 140, the on-board charger 330 can be composed of the AC-DC converter 331 and the DC-DC converter 332, and the AC-DC converter 141-1 and the DC-DC converter 141-2 can be composed of a plurality of switching elements, transformers, capacitors, inductors, etc. that constitute a bridge circuit.

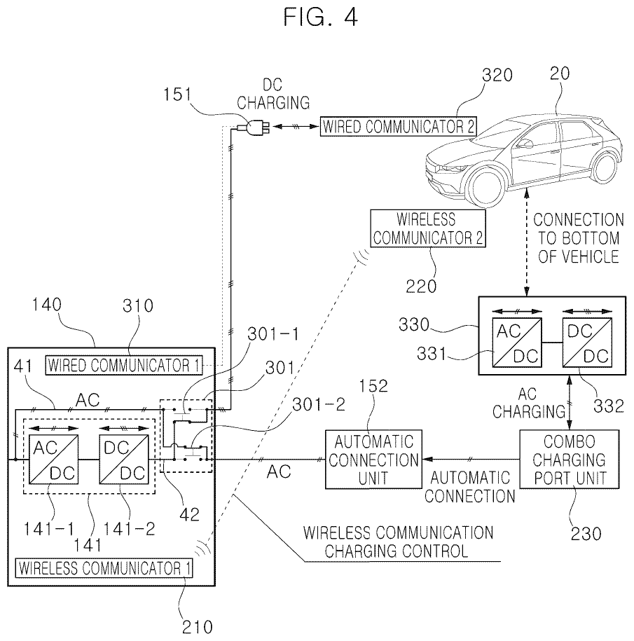

FIG. 4 is a conceptual diagram showing that charging control can be possible at maximum power regardless of which of two types of charging ports are used according to the concept of charging shown in FIG. 2, using an embodiment of the present disclosure. Referring to FIG. 4, according to the operation of the bypass circuit 301, a 2-1 AC charging line 41 sequentially connecting the input terminal of the AC-DC converter 141-1 of the power converter 141, the second switching element 301-2, the automatic connection unit 152, the combo charging port unit 230, and the on-board charger 330 can be formed.

Meanwhile, according to the operation of the bypass circuit 301, a 2-2 DC charging line 42 sequentially connecting the output terminal of the DC-DC converter 141-2 of the power converter 141, the first switching element 301-1, the charging connector 151, and the vehicle 20 can be formed.

Wired charging communication between the first wired communicator 310 configured in the external charger 140 and the second wired communicator 320 configured in the vehicle 20 can be performed through the charging connector 151 and the charging port of the vehicle. In addition, the wired charging communication can be performed based on charging communication standards such as International Organization for Standardization (ISO) 15118-2 and SAEJ1772.

Wireless charging communication between the first wireless communicator 210 configured in the external charger 140 and the second wireless communicator 220 configured in the vehicle 20 can be performed based on communication standards such as ISO 15118-20. Through such wireless charging communication, wireless communication charging control can be applied to the external charger 140 and the vehicle 20.

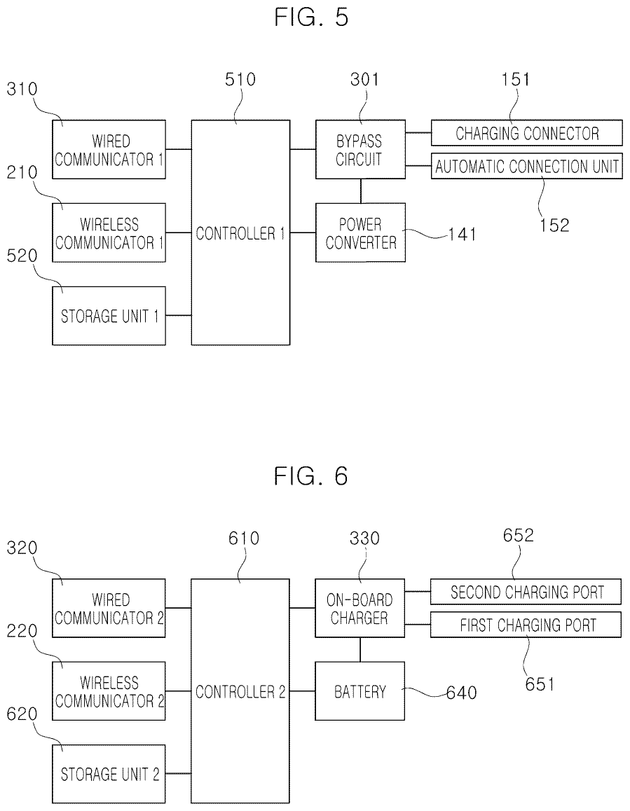

FIG. 5 is a block diagram of a configuration of the external charger 140 shown in FIG. 1. Referring to FIGS. 1 and 5, the external charger 140 may include the bypass circuit 301, the power converter 141, the charging connector 151, the automatic connection unit 152, the first wired communicator 310, the first wireless communicator 210, a first controller 510, a first storage unit 520, etc.

The first controller 510 can exchange data with the components configured in the external charger 140 and perform control. In particular, the first controller 510 can control the operation of the bypass circuit 301 to increase charging power and efficiently use the two charging ports. That is, the operations of the first switching element 301-1 and/or the second switching element 301-2 can be controlled to change the AC charging lines 31 and 41 and the DC charging lines 32 and 42 so that AC power and DC power can be efficiently supplied to the vehicle 20.

The first storage unit 520 can be a storage medium with functions to store a software program with an algorithm performed by the first controller 510, store data related to the software program, etc.

FIG. 6 is a block diagram of a configuration of the vehicle 20 shown in FIG. 2. Referring to FIG. 6, the vehicle 20 may include the second wireless communicator 220, the second wired communicator 320, the on-board charger 330, a second controller 610, a second storage unit 620, a battery 640, a first charging port 651, a second charging port 652, etc.

The second controller 610 can exchange data with the components configured in the vehicle 20 and perform control. In particular, the second controller 610 can control the operations of components by exchanging data with the external charger 140 through wired and wireless communication to increase charging power and efficiently use the two charging ports. That is, the second controller 610 can perform single charging or combined charging through cooperative control with the first controller 510 of the external charger 140 through wired or wireless communication.

The second storage unit 620 can be a storage medium with functions to store a software program with an algorithm performed by the second controller 610, store data related to the software program, etc.

The battery 640 can perform a function of storing charging power. That is, the DC power transmitted through the external charger 140 can be stored as charging power, or the DC power converted through the on-board charger 330 can be stored as charging power.

The battery 640 can include battery cells (not shown) configured in series and/or parallel, and the battery cells may be high-voltage battery cells for electric vehicles, such as nickel metal battery cells, lithium ion battery cells, lithium polymer battery cells, lithium sulfur battery cells, sodium sulfur battery cells, and all-solid-state battery cells. In general, a high-voltage battery can indicate a battery used as a power source for moving electric vehicles and can have a high voltage of 100 V or more. However, an embodiment of the present disclosure is not limited thereto, and low-voltage batteries can be also possible.

The battery 640 can have a concept that includes a battery management system (BMS), and the BMS can monitor a battery voltage, current, and temperature in real time and prevent excessive charging and discharging, thereby increasing the safety and reliability of the battery.

The first charging port 651 and/or the second charging port 652 can be combo-type charging ports and may be connected to all of the AC charging lines 31 and 41 and the DC charging lines 32 and 42. The first charging port 651 and/or the second charging port 652 can be mainly the CCS type, but are not limited thereto, and other types such as North American Charging Standard (NACS) may also be used.

The first charging port 651 and the second charging port 652 can be disposed at different locations. For example, the first charging port 651 may be disposed on the side surface of the vehicle 20, and the second charging port 652 may be disposed at the bottom or top of the vehicle 20.

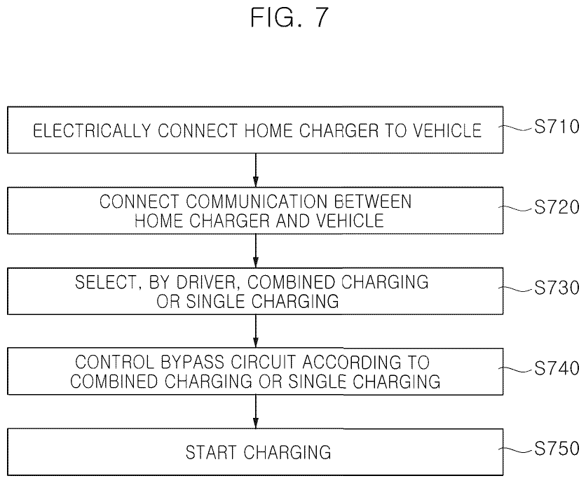

FIG. 7 is a flowchart showing a combined charging or single charging process according to an embodiment of the present disclosure. Referring to FIG. 7, the external charger 140 and the vehicle 20 can be electrically connected (operation S710). That is, as the charging connector 151 is connected to the first charging port 651 and the automatic connection unit 152 is connected to the combo charging port unit 230, the external charger 140 and the vehicle 20 can be electrically connected. In the case of the combined charging, both the charging ports 651 and 652 may be electrically connected, and in the case of the single charging, only one may be electrically connected.

Wired communication and/or wireless communication can be connected between the external charger 140 and the vehicle 20 (operation S720).

A driver can select combined charging or single charging (operation S730). When only one of the charging ports 651 and 652 is automatically connected, the single charging can be selected, and when both the charging ports 651 and 652 are connected, the combined charging can be selected. This can be generally automatically recognized by installing a detection sensor (not shown) at the charging port and may be implemented through a program for executing the corresponding charging procedure by allowing the first controller 510 and the second controller 610 to determine whether it is single charging or combined charging.

The first controller 510 can control the bypass circuit 301 to start charging according to the combined charging or the single charging (operations S740 and S750).

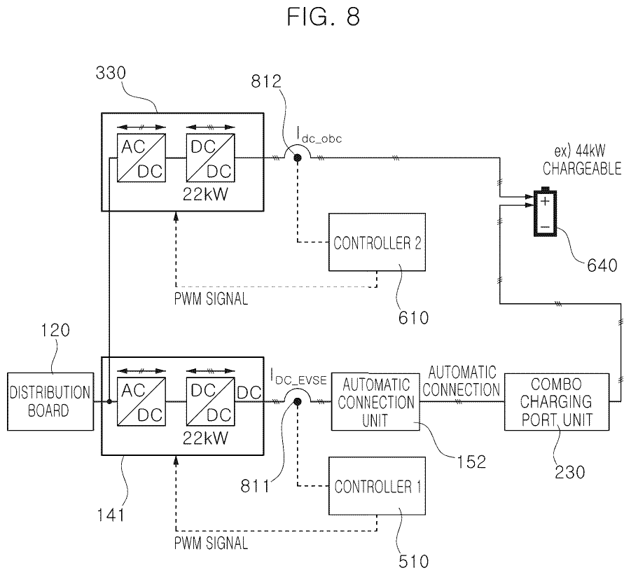

FIG. 8 is a conceptual diagram showing the execution of maximum charging through the combined charging according to an embodiment of the present disclosure. Referring to FIG. 8, as the charging connector 151 is connected to the first charging port 651 and at the same time, the automatic connection unit 152 is automatically connected to the combo charging port unit 230 (i.e., the second charging port 652), the external charger 140 and the vehicle 20 can become a state capable of electrically performing the combined charging.

The on-board charger 330 at the vehicle side and the power converter 141 of the external charger 140 can be arranged in parallel and controlled by a parallel operation. Therefore, the combined charging can be a capacity of the sum of the first charging power generated by the on-board charger 330 and the second charging power generated by the power converter 141. That is, the combined charging can be the sum of the charging capacity of the power converter 141 of the external charger 140 and the charging capacity of the on-board charger 330 inside the vehicle.

As shown in FIG. 8, a first sensor 811 for sensing a first output current IDC_EVSE can be disposed at the output terminal of the power converter 141 configured in the external charger 140. Therefore, the first controller 510 can apply a control signal to the power converter 141 using the first output current IDC_EVSE acquired through the first sensor 811. That is, the first controller 510 can control the on/off of the switching element configured in the power converter 141. The control signal may be a PWM signal, a pulse frequency modulation (PFM) signal, etc., for example.

In addition, a second sensor 812 for sensing a second output current Idc_obc can be also disposed at an output terminal of the on-board charger 330. Therefore, the second controller 610 can apply a control signal to the on-board charger 330 using the second output current Idc_obc acquired through the second sensor 812. That is, the second controller 610 can control the on/off of the switching element configured in the on-board charger 330.

The first and second sensors 811 and 812 can be mainly current sensors, but voltage sensors, etc. may be used. The current sensor may be a Hall sensor, a fiber optic current sensor, a current transformer (CT) type current sensor, etc., for example.

The on-board charger 330 and/or the power converter 141 may include a converter with an insulated structure. The converter with the insulated structure can be a DC-DC converter in which an input network and an output network are electrically insulated based on a transformer.

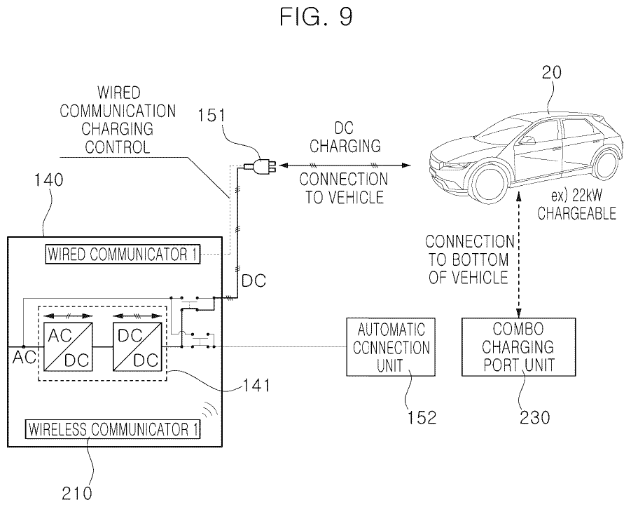

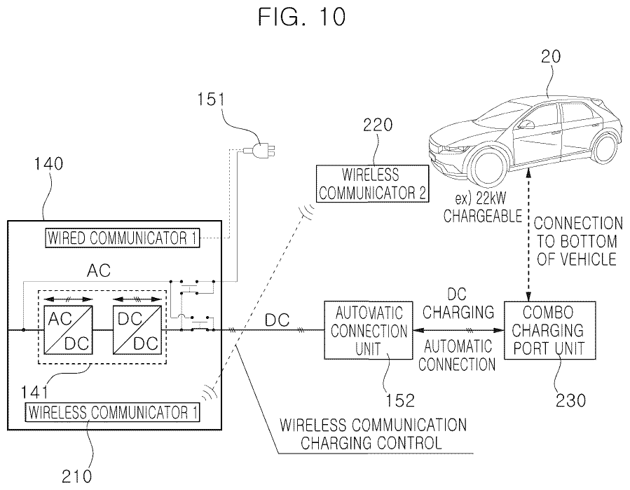

FIG. 9 is a conceptual diagram of single charging using only the conventional charging port (i.e., the first charging port 651) according to an embodiment of the present disclosure. Referring to FIG. 9, the automatic connection unit 152 and the combo charging port unit 230 are not connected, and only the charging connector 151 is connected to the first charging port 651 of the vehicle 20, for example. In this case, DC charging can be performed by the external charger 140 through wired communication charging control between the external charger 140 and the vehicle 20. That is, the external charger 140 can convert AC power into DC power and directly supply DC charging power to the vehicle.

FIG. 10 is a conceptual diagram of single charging using only an automatic connection device (ADC) according to an embodiment of the present disclosure. In particular, FIG. 10 is a conceptual diagram of single charging using only the ACD-U. Differently from FIG. 9, in FIG. 10, only the automatic connection unit 152 and the combo charging port unit 230 are connected, and the charging connector 151 is not connected to the first charging port 651 of the vehicle 20, for example. In this case, DC charging can be performed by the external charger 140 through wireless communication charging control between the external charger 140 and the vehicle 20. That is, the external charger 140 can convert AC power into DC power and directly supply DC charging power to the vehicle 20.

That is, in FIGS. 9 and 10, when the external charger 140 and the vehicle 20 are selectively connected in one manner, single charging can be performed.

The operations of the method or algorithm described in relation to the embodiments disclosed herein may be implemented in the form of program commands that may be executed through various computer devices such as a microprocessor, a processor, and a CPU and stored in a computer-readable medium. The computer-readable medium may include program (command) codes, data files, data structures, etc. alone or in combination.

What is claimed is:

1. A charging control system comprising:
a vehicle having an on-board charger connected to a plurality of charging ports; and
an external charger electrically and communicatively connected to the vehicle, wherein the external charger is configured to provide one of or both of first charging power converted by transmitting supply power from a distribution board to the on-board charger and second charging power converted through a built-in power converter, so that single charging or combined charging can be performed by changing connection among a plurality of charging lines.

2. The system of claim 1, wherein the plurality of charging lines include an AC charging line configured to supply through AC power to the on-board charger and a DC charging line configured to supply DC power to the vehicle using the external charger without passing through the on-board charger.

3. The system of claim 2, wherein the AC charging line is connected between an output terminal of the distribution board and an input terminal of the power converter and is disconnected in the external charger.

4. The system of claim 2, wherein the plurality of charging ports are combo-type charging ports connected to both the AC charging line and the DC charging line.

5. The system of claim 2, wherein the DC charging line is connected to an output terminal of a DC-DC converter configured in the power converter.

6. The system of claim 1, wherein the single charging is performed in response to a charging connector installed on the external charger being connected to a first charging port among the plurality of charging ports, or an automatic connection unit installed on the external charger being automatically connected to a second charging port among the plurality of charging ports configured in a combo charging port unit installed in the vehicle.

7. The system of claim 1, wherein the combined charging is performed in response to a charging connector installed on the external charger being connected to a first charging port among the plurality of charging ports, and at a same time, an automatic connection unit installed on the external charger being automatically connected to a second charging port among the plurality of charging ports configured in a combo charging port unit installed in the vehicle.

8. The system of claim 7, wherein the automatic connection unit and the combined charging port unit are connected by using a wireless charging method, an automatic connection device-underbody (ACD-U), or an automatic connection device-sidebody (ACD-S).

9. The system of claim 1, wherein the combined charging is a capacity of a sum of the first charging power generated by the on-board charger and the second charging power generated by the power converter by controlling the on-board charger and the power converter through a parallel operation.

10. The system of claim 1, wherein the external charger includes a bypass circuit having a plurality of switching elements connected in parallel so that the plurality of charging lines are changed.

11. The system of claim 1, wherein the plurality of charging ports are disposed at different locations of the vehicle.

12. The system of claim 1, further comprising:
a first sensor disposed at a first output terminal of the power converter configured to sense a first output current to apply a first control signal to the power converter; and
a second sensor disposed at a second output terminal of the on-board charger configured to sense a second output current to apply a second control signal to the on-board charger.

13. The system of claim 1, wherein the on-board charger and the power converter are converters with an insulated structure in which an input circuit network and an output circuit network are insulated electrically by a transformer structure.

14. A charging control method comprising:
electrically and communicatively connecting a vehicle having an on-board charger connected to a plurality of charging ports to an external charger having a built-in power converter; and
performing, by the external charger, single charging or combined charging that provides one of or both of first charging power converted by transmitting supply power from a distribution board to the on-board charger and second charging power converted through the power converter.

15. The method of claim 14, wherein the external charger comprises a plurality of charging lines, and wherein the plurality of charging lines include an AC charging line through which AC power can be supplied to the on-board charger and a DC charging line through which DC power can be directly supplied to the vehicle using the external charger without passing through the on-board charger.

16. The method of claim 14, wherein the single charging is performed in response to a charging connector installed on the external charger being connected to a first charging port among the plurality of charging ports, or an automatic connection unit installed on the external charger being automatically connected to a second charging port among the plurality of charging ports configured in a combo charging port unit installed in the vehicle.

17. The method of claim 14, wherein the combined charging is performed in response to a charging connector installed on the external charger being connected to a first charging port among the plurality of charging ports, and at a same time, an automatic connection unit installed on the external charger being automatically connected to a second charging port among the plurality of charging ports configured in a combo charging port unit installed in the vehicle.

18. The method of claim 14, wherein the combined charging is a capacity of a sum of the first charging power generated by the on-board charger and the second charging power generated by the power converter by controlling the on-board charger and the power converter through a parallel operation.

19. The method of claim 14, wherein the external charger includes a bypass circuit having a plurality of switching elements connected in parallel so that a plurality of charging lines can be changed.

20. A charging control system comprising an external charger configured to be electrically and communicatively connected to a vehicle, wherein the external charger comprises:
a controller;
a built-in power converter;
a plurality of charging lines, wherein at least one of the plurality of charging lines is connected to the built-in power converter; and
a bypass circuit electrically connected to the controller, wherein the bypass circuit include switches electrically connected to the plurality of charging lines, and wherein the bypass circuit is configured to provide one of or both of first charging power converted by transmitting supply power from a distribution board to an on-board charger of the vehicle and second charging power converted through the built-in power converter of the external charger, so that single charging or combined charging can be performed by changing connection among the plurality of charging lines using the switches of the bypass circuit.
